(19) United States
(12) Patent Application Publication
(10) Pub. No.: US 2026/0091605 A1
(43) Pub. Date: Apr. 2, 2026

(54) PRINTING APPARATUS AND PRINTING METHOD

(71) Applicant: SEIKO EPSON CORPORATION, Tokyo (JP)

(72) Inventor: Hiroshi TOYAMA, SHIOJIRI-SHI (JP)

(21) Appl. No.: 19/345,352

(22) Filed: Sep. 30, 2025

(30) Foreign Application Priority Data
Oct. 1, 2024 (JP) 2024-172047

(51) Int. Cl. B41J 29/393; B41J 11/00; B41J 15/04; B41M 3/00

(52) U.S. Cl. CPC B41J 29/393; B41J 11/008; B41J 15/04; B41M 3/008; B41J 2029/3935

(57) ABSTRACT

A printing apparatus that carries out a first step of forming, on a medium, a first pattern having a first linear portion, a second step of conveying the medium by a predetermined amount after the first pattern is formed, a third step of forming, after the medium is conveyed by the predetermined amount, a second pattern having a second linear portion at a position where at least a part of the second linear portion overlaps the first linear portion located at a first ideal position when viewed in a width direction and where there is a gap between the first linear portion located at the first ideal position and the second linear portion in the width direction, a fourth step of detecting a first intersection and a second intersection while moving the sensor to traverse an overlapping portion of the first linear portion located at the first ideal position and the second linear portion when viewed in the width direction, and a fifth step of calculating a conveyance error of the medium in the second step based on the first intersection and the second intersection detected in the fourth step and correcting a conveyance amount of the medium by a conveyance unit.

The present application is based on, and claims priority from JP Application Serial Number 2024-172047, filed Oct. 1, 2024, the disclosure of which is hereby incorporated by reference herein in its entirety.

### BACKGROUND

### 1. Technical Field

The present disclosure relates to a printing apparatus and a printing method.

### 2. Related Art

Various printing apparatuses have been used. Among the printing apparatuses, there is a printing apparatus that performs printing on a conveyed medium. The printing apparatus having the configuration explained above is likely to cause a conveyance error because of a difference in thickness, a difference in ease of stretching at the time when tension is applied, a difference in a degree of swelling at the time when ink or the like is applied, or the like depending on a medium to be used. Therefore, a printing apparatus capable of detecting a conveyance error is disclosed. For example, JP-A-2007-176166 discloses an inkjet recording apparatus that forms, on a medium, a first pattern formed by nonparallel two straight lines and, after conveying the medium in a conveyance direction by a predetermined amount, forms, at a position not overlapping the first pattern, a second pattern formed by the same two straight lines as those forming the first pattern and simultaneously reads the first pattern and the second pattern with a line scanner. Then, the inkjet recording apparatus respectively calculates an intersection of the two straight lines of the first pattern and an intersection of the two straight lines of the second pattern and compares a distance in the conveyance direction between the two intersections and the predetermined amount of the conveyance of the medium to detect a conveyance error.

JP-A-2007-176166 is an example of the related art.

However, in the printing apparatus of the related art capable of detecting a conveyance error, such as the inkjet recording apparatus disclosed in JP-A-2007-176166, time and effort are sometimes required to detect and correct the conveyance error. In such a printing apparatus, a large sensor or a high-accuracy encoder tends to be introduced, causing an increase in a driving load or an increase in apparatus cost involved in the introduction. For example, in the inkjet recording apparatus disclosed in JP-A-2007-176166, the line scanner is used to read the first pattern and the second pattern. Since the line scanner increases in size, there is a risk of causing an increase in the driving load, an increase in the apparatus cost, and the like.

### SUMMARY

In order to solve the above problems, according to an aspect of the present disclosure, there is provided a printing apparatus including: a conveyance unit configured to convey a medium in a conveyance direction; a printing unit configured to discharge liquid onto the medium conveyed by the conveyance unit; a sensor capable of moving in a width direction orthogonal to the conveyance direction and detecting a detection pattern formed by discharging the liquid onto the medium; and a control unit, the control unit carrying out: a first step of controlling the printing unit to form, on the medium, a first pattern having a first linear portion that is one linear portion constituting the detection pattern and intersecting both of the conveyance direction and the width direction; a second step of controlling the conveyance unit to convey the medium by a predetermined amount after the first pattern is formed; a third step of controlling the printing unit to, when a position where the first linear portion is located when the medium is conveyed by the predetermined amount without causing a conveyance error in the second step is defined as a first ideal position, after the medium is conveyed by the predetermined amount, form, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction; a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and a fifth step of calculating the conveyance error of the medium in the second step based on the first intersection and the second intersection detected in the fourth step and correcting a conveyance amount of the medium by the conveyance unit.

In order to solve the above problems, according to another aspect of the present disclosure, there is provided a printing method for a printing apparatus including: a conveyance unit configured to convey a medium in a conveyance direction; a printing unit configured to discharge liquid onto the medium conveyed by the conveyance unit; and a sensor capable of moving in a width direction orthogonal to the conveyance direction and detecting a detection pattern formed by discharging the liquid onto the medium, the printing method carrying out: a first step of forming, by the printing unit, on the medium, a first pattern having a first linear portion that is one linear portion constituting the detection pattern and intersecting both of the conveyance direction and the width direction; a second step of conveying the medium by a predetermined amount by the conveyance unit after the first pattern is formed; a third step of, when a position where the first linear portion is located when the medium is conveyed by the predetermined amount without causing a conveyance error in the second step is defined as a first ideal position, after the medium is conveyed by the predetermined amount, forming, by the printing unit, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction; a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and a fifth step of calculating the conveyance error of the medium in the second step based on the first intersection and the second intersection detected in the fourth step and correcting a conveyance amount of the medium by the conveyance unit.

### BRIEF DESCRIPTION OF THE DRAWINGS

FIG. 1 is a perspective view of a printing apparatus according to a first embodiment of the present disclosure.

FIG. 2 is a perspective view illustrating the inside of the printing apparatus illustrated in FIG. 1.

FIG. 3 is a perspective view illustrating the inside of the printing apparatus illustrated in FIG. 1 and is a diagram illustrating a state in which a carriage cover is removed.

FIG. 4 is a perspective view illustrating an internal configuration of a carriage of the printing apparatus illustrated in FIG. 1.

FIG. 5 is a diagram illustrating a medium on which printing is performed by the printing apparatus illustrated in FIG. 1 and illustrating an example of a printing state of a first frame.

FIG. 6 is a flowchart illustrating a printing method performed by the printing apparatus illustrated in FIG. 1 in an example of a case in which a first pattern and a second pattern illustrated in FIG. 5 are formed.

FIG. 7 is a schematic diagram illustrating a printing state in the flowchart of FIG. 6.

FIG. 8 is a schematic diagram illustrating a positional relationship between the first pattern and the second pattern in the case in which a conveyance error has not occurred and the case in which the conveyance error has occurred.

FIG. 9 is a schematic diagram illustrating a positional relationship between a first pattern and a second pattern having shapes different from the shapes of the first pattern and the second pattern illustrated in FIGS. 5 and 8 in the case in which the conveyance error has not occurred.

FIG. 10 is a flowchart illustrating a printing method performed by the printing apparatus illustrated in FIG. 1 in an example of a case in which the first pattern and the second pattern illustrated in FIG. 9 are formed.

### DESCRIPTION OF EMBODIMENTS

First, the present disclosure is schematically explained.

In order to solve the above problems, according to a first aspect of the present disclosure, there is provided a printing apparatus including: a conveyance unit configured to convey a medium in a conveyance direction; a printing unit configured to discharge liquid onto the medium conveyed by the conveyance unit; a sensor capable of moving in a width direction orthogonal to the conveyance direction and detecting a detection pattern formed by discharging the liquid onto the medium; and a control unit, the control unit carrying out: a first step of controlling the printing unit to form, on the medium, a first pattern having a first linear portion that is one linear portion constituting the detection pattern and intersecting both of the conveyance direction and the width direction; a second step of controlling the conveyance unit to convey the medium by a predetermined amount after the first pattern is formed; a third step of controlling the printing unit to, when a position where the first linear portion is located when the medium is conveyed by the predetermined amount without causing a conveyance error in the second step is defined as a first ideal position, after the medium is conveyed by the predetermined amount, form, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction; a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and a fifth step of calculating the conveyance error of the medium in the second step based on the first intersection and the second intersection detected in the fourth step and correcting a conveyance amount of the medium by the conveyance unit.

According to this aspect, the printing apparatus includes the sensor capable of moving in the width direction orthogonal to the conveyance direction and detecting the detection pattern formed by discharging the liquid onto the medium and detects the detection pattern before and after the medium is conveyed by the predetermined amount to calculate the conveyance error and corrects the conveyance amount of the medium by the conveyance unit. As explained above, since the printing apparatus is configured to detect the detection pattern using a small sensor capable of moving in the width direction orthogonal to the conveyance direction and calculate the conveyance error, it is possible to reduce a risk of causing an increase in a driving load, an increase in apparatus cost, and the like. It is possible to print the detection pattern and automatically correct the conveyance error of the medium with the sensor and it is possible to reduce a risk of requiring time and effort to detect or correct the conveyance error.

A printing apparatus according to a second aspect of the present disclosure is the printing apparatus according to the first aspect, wherein, in the fifth step, the conveyance error may be calculated as (B−C) tan θ, where a distance in the width direction between a position of the first intersection and a position of the second intersection is B, a reference distance, which is a theoretical value in the width direction between the first linear portion and the second linear portion is C, and an angle obtained by subtracting a tilt of the first linear portion with respect to the conveyance direction from 90 degrees is θ.

According to this aspect, the conveyance error is calculated as (B−C) tan θ. By calculating the conveyance error as explained above, the conveyance error can be accurately and easily calculated.

A printing apparatus according to a third aspect of the present disclosure is the printing apparatus according to the second aspect, wherein the first pattern may have a third linear portion that is one linear portion parallel to the conveyance direction, the second pattern may have a fourth linear portion that is one linear portion parallel to the conveyance direction, in the third step, the fourth linear portion may be formed at a position where at least a part of the fourth linear portion overlaps the third straight linear portion located in the first ideal position when viewed in the width direction and where there is a gap between the third linear portion located at the first ideal position and the fourth linear portion in the width direction, and the control unit may carry out, between the third step and the fifth step, a sixth step of, while moving the sensor to traverse, in the width direction, an overlapping portion where the third linear portion located at the first ideal position and the fourth linear portion when viewed in the width direction overlap, detecting a third intersection that is a position where the third linear portion and the sensor intersect and a fourth intersection that is a position where the fourth linear portion and the sensor intersect, and, in the fifth step, a distance in the width direction between the third intersection and the fourth intersection may be used instead of the reference distance.

According to this aspect, the detection pattern has the third linear portion and the fourth linear portion, and the conveyance amount of the medium by the conveyance unit is corrected in the fifth step using the third linear portion and the fourth linear portion. By correcting the conveyance amount of the medium as explained above, it is possible to accurately correct the conveyance amount of the medium based on an actual measurement value.

A printing apparatus according to a fourth aspect of the present disclosure is the printing apparatus according to any one of the first to third aspects, wherein a length of a detection region in the conveyance direction of the sensor may be shorter than a length of the overlapping portion in the conveyance direction.

According to this aspect, the length of the detection region in the conveyance direction of the sensor is shorter than the length of the overlapping portion in the conveyance direction. With the configuration explained above, it is possible to particularly reduce the sensor in size, and it is possible to particularly effectively suppress an increase in the driving load, an increase in the apparatus cost, and the like.

A printing apparatus according to a fifth aspect of the present disclosure is an aspect according to any one of the first to fourth aspects, further including a storage unit configured to store types of media selectable as the medium and the conveyance errors corresponding to the respective types of the media in association with each other, wherein, when the conveyance error corresponding to a type of the medium to be used is not stored in the storage unit when starting printing, the control unit may carry out the first step to the fifth step and calculate the conveyance error corresponding to the type of the medium to be used.

According to this aspect, if data in which a type of a medium and a conveyance error corresponding the type are associated is present in the storage unit, the conveyance error can be calculated based on the data. With the configuration explained above, it is possible to simplify a correction process for the conveyance error.

A printing apparatus according to a sixth aspect of the present disclosure is the printing apparatus according to the fifth aspect, wherein, after calculating the conveyance error corresponding to the type of the medium to be used, the control unit may cause the storage unit to store the type of the medium to be used and the calculated conveyance error in association with each other.

According to this aspect, after calculating the conveyance error corresponding to the type of the medium to be used, the control unit causes the storage unit to store the type of the medium to be used and the calculated conveyance error in association with each other. With the configuration explained above, it is possible to increase types of media that can simplify the correction process for the conveyance error.

A printing apparatus according to a seventh aspect of the present disclosure is the printing apparatus according to any one of the first to fourth aspects, wherein the control unit may carry out the first to fifth steps every time a print job is executed and calculate the conveyance error.

According to this aspect, every time a print job is executed, the control unit carries out the first to fifth steps and calculates the conveyance error. With the configuration explained above, since the conveyance error is corrected every time the print job is executed, it is possible to accurately correct the conveyance error without being affected by, for example, a use environment of the printing apparatus.

A printing apparatus according to an eighth aspect of the present disclosure is the printing apparatus according to any one of the first to seventh aspects, wherein, in the first step, the control unit may form the first pattern on the medium by printing, on the medium, image data obtained by combining image data to be printed in a print job and image data of the first pattern and, in the third step, form the second pattern on the medium by printing, on the medium, image data obtained by combining the image data to be printed in the print job and image data of the second pattern.

According to this aspect, the control unit combines the image data to be printed in the print job and the image data of the first pattern and the second pattern. With the configuration explained above, it is possible to correct the conveyance error taking into account a degree of swelling and shrinkage of the medium due to an adhesion amount of liquid involved in an image being printed in the print job.

According to ninth aspect of the present disclosure, there is provided a printing method for a printing apparatus including: a conveyance unit configured to convey a medium in a conveyance direction; a printing unit configured to discharge liquid onto the medium conveyed by the conveyance unit; and a sensor capable of moving in a width direction orthogonal to the conveyance direction and detecting a detection pattern formed by discharging the liquid onto the medium, the printing method carrying out: a first step of forming, by the printing unit, on the medium, a first pattern having a first linear portion that is one linear portion constituting the detection pattern and intersecting both of the conveyance direction and the width direction; a second step of conveying the medium by a predetermined amount by the conveyance unit after the first pattern is formed; a third step of, when a position where the first linear portion is located when the medium is conveyed by the predetermined amount without causing a conveyance error in the second step is defined as a first ideal position, after the medium is conveyed by the predetermined amount, forming, by the printing unit, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction; a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and a fifth step of calculating the conveyance error of the medium in the second step based on the first intersection and the second intersection detected in the fourth step and correcting a conveyance amount of the medium by the conveyance unit.

According to this aspect, the conveyance error is calculated by detecting, using the sensor capable of moving in the width direction orthogonal to the conveyance direction and detecting the detection pattern formed by discharging the liquid onto the medium, the detection pattern before and after conveying the medium by the predetermined amount and the conveyance amount of the medium by the conveyance unit is corrected. As explained above, since the printing apparatus is configured to detect the detection pattern using a small sensor capable of moving in the width direction orthogonal to the conveyance direction and calculate the conveyance error, it is possible to reduce a risk of causing an increase in a driving load, an increase in apparatus cost, and the like. It is possible to print the detection pattern and automatically correct the conveyance error of the medium with the sensor and it is possible to reduce a risk of requiring time and effort to detect or correct the conveyance error.

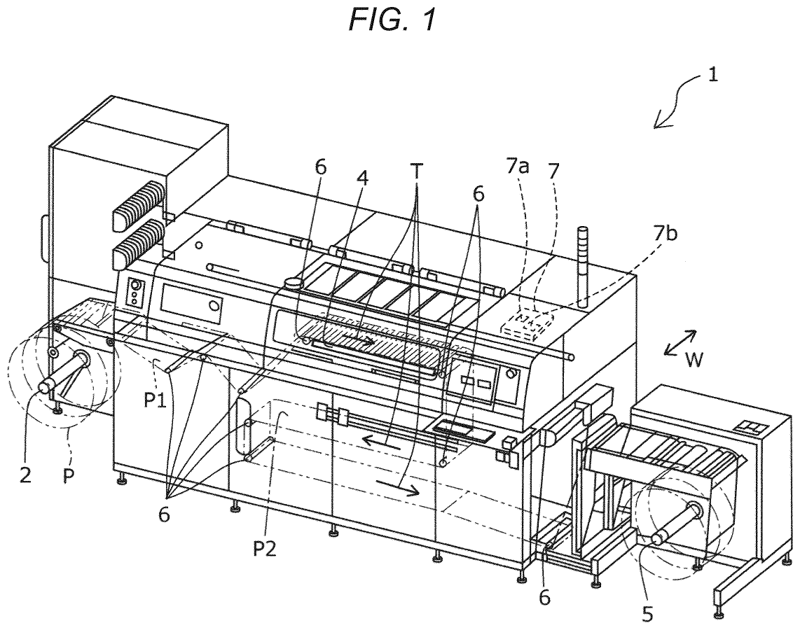

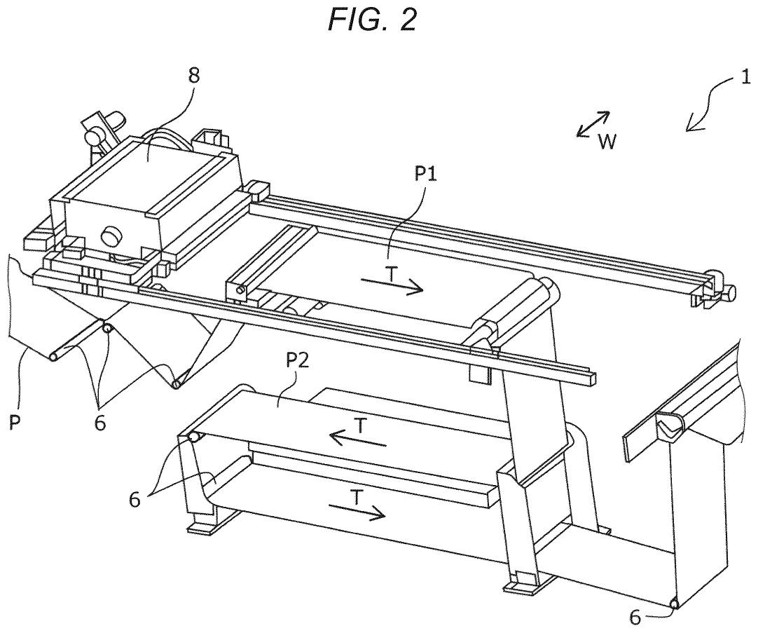

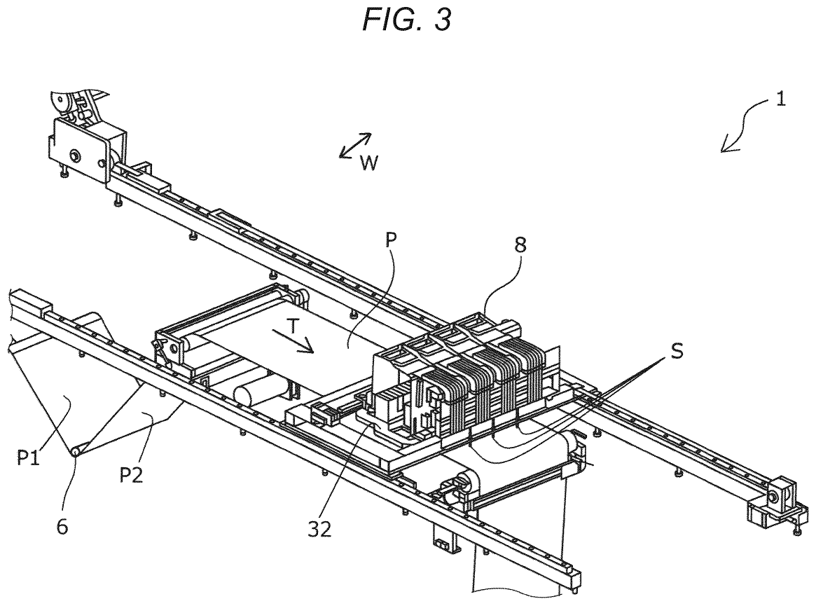

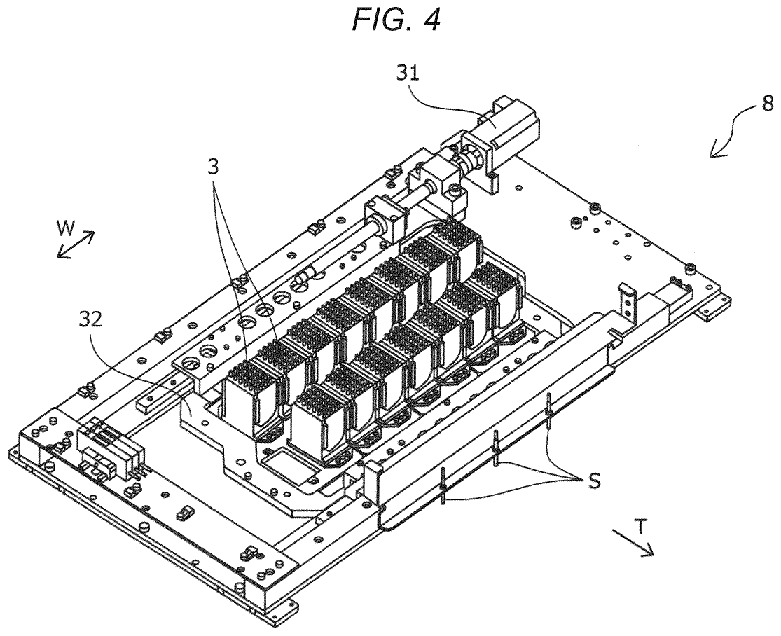

Hereinafter, an embodiment according to the present disclosure is specifically explained with reference to the drawings. First, an overview of a printing apparatus 1 according to the embodiment of the present disclosure is explained with reference to FIGS. 1 to 4. As illustrated in FIG. 1, the printing apparatus 1 according to the present embodiment includes a setting unit 2 in which a roll-shaped medium P is set, a winding unit 5 that winds the medium P conveyed from the setting unit 2, and a carriage 8 including a printing head 3 serving as a printing unit that discharging liquid ink onto a printing surface P1 of the medium P conveyed in a conveyance direction T in a conveyance path from the setting unit 2 to the winding unit 5 to form an image. As illustrated in FIGS. 3 and 4, a sensor S explained in detail below is provided in the carriage 8.

The printing apparatus 1 includes a platen 4 that supports the medium P in an image forming region where an image is formed by the printing head 3 and a plurality of rollers 6 provided in the conveyance path of the medium P are provided. The rollers 6 configure a conveyance unit that conveys the medium P in the conveyance direction T. Further, the printing apparatus 1 in the present embodiment includes a control unit 7 including a CPU 7a and a storage unit 7b. The constituent members of the printing apparatus 1 in the present embodiment are driven by the control of the control unit 7. The control unit 7 can receive input of information concerning the medium P to be used from an external computer or the like connected to the printing apparatus 1 in the present embodiment.

The printing head 3 is provided on a side facing the printing surface P1 of the medium P conveyed in the conveyance direction T and discharges ink to the printing surface P1 to form an image in a state in which a rear surface P2 on a side opposite to the printing surface P1 of the medium P is supported by the platen 4. Specifically, the printing apparatus 1 in the present embodiment performs printing by reciprocating the carriage 8 in a scanning direction in the conveyance direction T. More specifically, the printing apparatus 1 in the present embodiment intermittently drives (intermittently conveys) the medium P in the conveyance direction T, reciprocates the carriage 8 in the scanning direction (conveyance direction T), and discharges ink from the printing head 3 to perform printing.

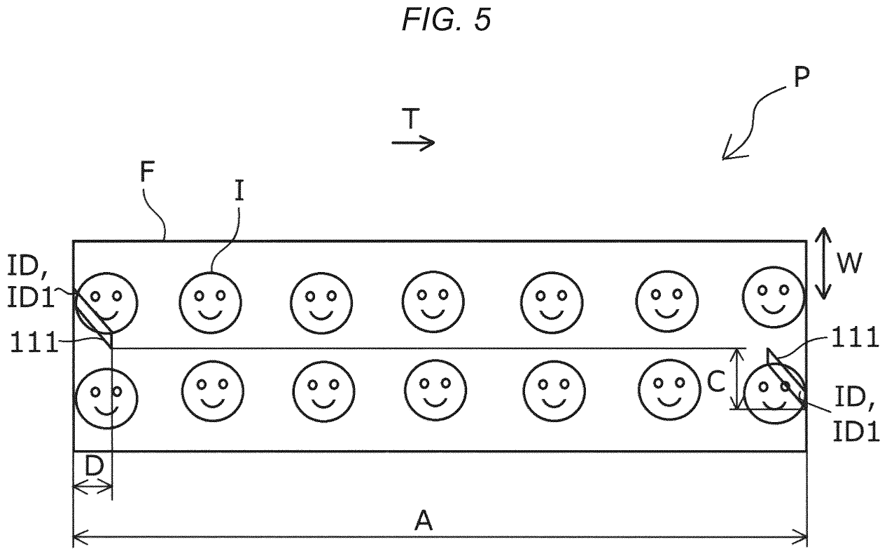

The printing head 3 in the present embodiment can complete image formation in the entire image forming region supported by the platen 4 on the printing surface P1 in one scan (one path), for example, an entire frame F corresponding to a printing region in one intermittent conveyance illustrated in FIG. 5. On the other hand, the printing head 3 can also complete the image formation by scanning a region corresponding to the frame F a plurality of times (a plurality of paths). Compared with when the image formation is completed in one path, when the image formation is completed in the plurality of paths, a conveyance stop time of the medium P involved in the intermittent conveyance is naturally longer.

As illustrated in FIG. 4, the carriage 8 in the present embodiment includes a driving unit 31 that moves the printing head 3 on the inside of the carriage 8 in a width direction W orthogonal to the conveyance direction T. The carriage 8 includes the sensor S at a position coupled to a region 32 where the printing head 3 is mounted. It is possible to detect an end portion of the medium P with the sensor S. Since the region 32 can be moved in the width direction W by driving the driving unit 31, the sensor S can also move in the width direction.

Here, in the printing apparatus 1 in the present embodiment, a conveyance error E of the conveyed medium P is detected using the sensor S. As illustrated in FIG. 4, the carriage 8 in the present embodiment includes three sensors S. The three sensors S is provided because a driving stroke of the region 32 is short with respect to the width of the medium P desired to be detected. The printing apparatus 1 in the present embodiment can detect a detection pattern ID explained below with at least one of the three sensors S.

As explained above, the printing apparatus 1 in the present embodiment includes the plurality of rollers 6 that convey the medium P in the conveyance direction T, the printing head 3 that discharges ink, which is liquid, onto the medium P conveyed by the rollers 6, the sensor S capable of moving in the width direction W orthogonal to the conveyance direction T and detecting the detection pattern ID formed by discharging the ink onto the medium P, and the control unit 7. With the control of the control unit 7, it is possible to correct the conveyance error E of the medium P based on a detection result of the detection pattern ID by the sensor S.

Subsequently, a detection method for the conveyance error E is explained. FIG. 5 is an image pattern including an image I to be printed on the medium P in main printing and detection pattern IDs inserted at the front end and the rear end of the frame F. In the conveyance direction T, a downstream side is referred to as the front end of the frame F and an upstream side is referred to as the rear end of the frame F. In the present embodiment, a first pattern ID1 serving as the detection pattern ID has a first linear portion 111 that is one linear portion intersecting both of the conveyance direction T and the width direction W. A second pattern ID2 explained below printed subsequent to the first pattern ID1 has a second linear portion 112 that is one linear portion intersecting both of the conveyance direction T and the width direction W. Here, the main printing is actual printing of the target image I, and provisional printing is printing for adjustment before the main printing.

Here, since a conveyance amount of the medium P corresponding to the length in the conveyance direction T of the frame F is determined by the size and arrangement of the image I to be actually printed, the amount (the length in the conveyance direction T of the frame F) is represented as A. Then, the detection pattern ID having the same shape is included in the front end and the rear end of the actually printed image I. At this time, the detection pattern ID of the front end and the detection pattern ID of the rear end are shifted in the width direction W. A distance in the width direction W is represented as C. Here, the distance C corresponds to a reference distance that is a theoretical value in the width direction W between the first linear portion 111 and the second linear portion 112 calculated from image data. The length in the conveyance direction T of the detection pattern ID is represented as D.

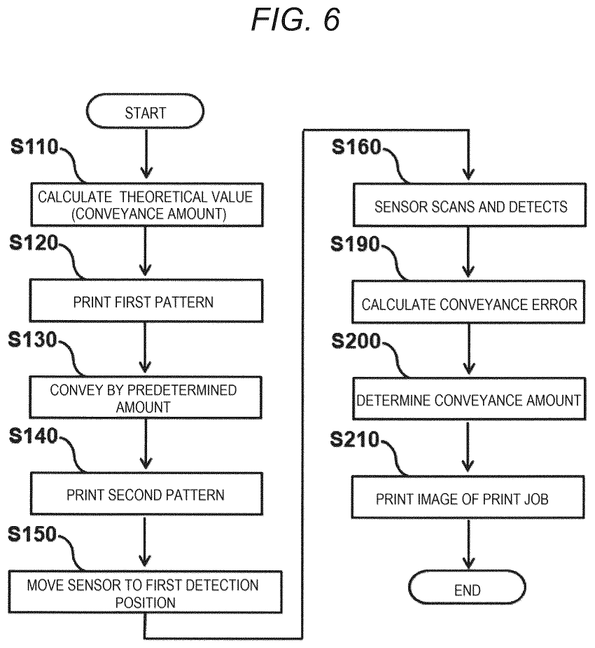

Subsequently, a printing method of calculating the conveyance error E by continuously forming the frames F in which the detection pattern ID is formed and correcting the conveyance error E is explained with reference to a flowchart of FIG. 6 and with reference to FIG. 5. First, as illustrated in step S110, the control unit 7 calculates the conveyance amount of the medium P as a theoretical value from the size, arrangement, and the like of the image I to be actually printed.

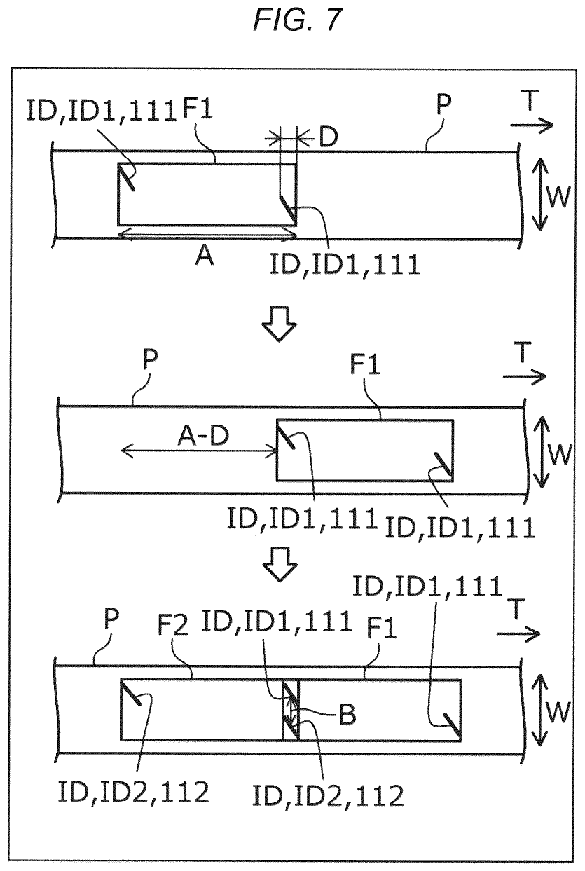

Subsequently, in step S120, the first pattern ID1 represented by the image pattern illustrated in FIG. 5 is printed before conveyance of the medium P corresponding to a frame F1 serving as the frame F. Here, an upper figure of FIG. 7 illustrates a state after the end of step S120. In the upper figure of FIG. 7, the detection pattern IDs are printed respectively at the front end and the rear end of the frame F1 in the first pattern ID1. However, the detection pattern ID may be printed only at the rear end.

After the end of step S120, in step S130, the medium P corresponding to the frame F1 is conveyed, that is, the frame is fed. Here, a middle figure of FIG. 7 illustrates a state after the end of step S130. In step S130, the conveyance amount of the medium P is set to A to D such that the detection pattern ID of the rear end formed by the printing of the first pattern ID1 before the frame feeding and the detection pattern ID of the front end formed by printing (step S140 explained later) of the second pattern ID2 after the frame feeding are at overlapping positions when viewed in the width direction W.

After the end of step S130, in step S140, the second pattern ID2, which is the same image pattern as the first pattern ID1, is printed again. By executing step S140, the detection pattern ID of the rear end of the first pattern ID1 before the frame feeding and the detection pattern ID of the front end of the second pattern ID2 are printed at the same position in the conveyance direction T. A lower figure of FIG. 7 illustrates a state after the end of step S140. In the lower figure of FIG. 7, the detection pattern IDs are respectively printed at the front end and the rear end of a frame F2 in the second pattern ID2. However, the detection pattern ID may be printed only at the front end.

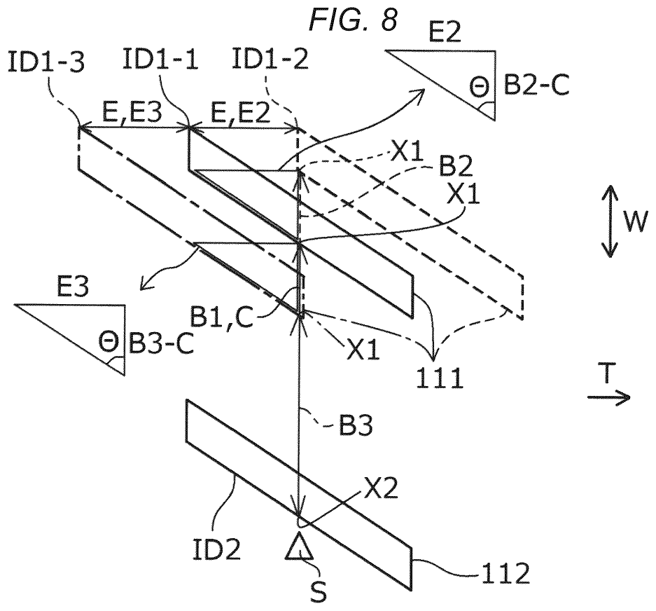

After the detection pattern ID of the front end of the second pattern ID2 is printed in step S140, in step S150, the control unit 7 controls driving of the driving unit 31 to move the position of the sensor S of the carriage 8 in the conveyance direction T to a position where the detection pattern ID of the rear end of the first pattern ID1 and the detection pattern ID of the front end of the second pattern ID2 overlap in the conveyance direction T as illustrated in FIG. 8. Thereafter, in step S160, the sensor S is scanned in the width direction W to detect the detection pattern ID of the rear end of the first pattern ID1 and the detection pattern ID of the front end of the second pattern ID2.

In step S190 after step S160, the control unit 7 obtains a distance B between the detection pattern ID of the rear end of the actually printed first pattern ID1 and the detection pattern ID of the front end of the actually printed second pattern ID2 from a detection result by the sensor S in step S160 and calculates the conveyance error E from the distance B. Then, in step S200, the control unit 7 determines a conveyance amount based on the conveyance error E, that is, corrects the conveyance error E and, in step S210, performs printing of an image pattern of a printing job that is the main printing. The printing of the image patterns in steps S120 and S140 corresponds to the provisional printing before the main printing in step S210.

As explained above, the printing apparatus 1 in the present embodiment is capable of executing the following steps by controlling the control unit 7. As a first step, the printing apparatus 1 is capable of executing step S120, illustrated in an upper part of FIG. 7, of forming, on the medium P, with the printing head 3, the first pattern ID1, constituting the detection pattern ID, and having the first linear portion 111 that is one linear portion intersecting both of the conveyance direction T and the width direction W.

In addition, as a second step, the printing apparatus 1 is capable of executing step S130, illustrated in a middle part of FIG. 7, of conveying the medium P by a predetermined amount with the rollers 6 after forming the first pattern ID1. Here, the predetermined amount is a values A−D obtained by subtracting a length D in the conveyance direction T of the detection pattern ID from a length A in the conveyance direction T of the frame F.

As a third step, the printing apparatus 1 is capable of executing step S140 illustrated in a lower part of FIG. 7. Specifically, when a position where the first linear portion 111 is located when the medium P is conveyed by the predetermined amount without causing the conveyance error E in step S130 is defined as a first ideal position, after the medium P is conveyed by the predetermined amount, the printing apparatus 1 forms, with the printing head 3, on the medium P, at a position where at least a part of the second linear portion 112 overlaps the first linear portion 111 located at the first ideal position when viewed in the width direction W and where there is a gap between the first linear portion 111 located at the first ideal position and the second linear portion 112 in the width direction W, the second pattern ID2 having the second linear portion 112 that is one linear portion constituting the detection pattern ID and parallel to the first linear portion 111.

As a fourth step, the printing apparatus 1 is capable of executing step S150 and step S160. In step S150 and step S160, while moving the sensor S to traverse, in the width direction W, an overlapping portion where the first linear portion 111 located at the first ideal position and the second linear portion 112 when viewed in the width direction W overlap, the printing apparatus 1 detects a first intersection X1 (see FIG. 8) that is a position where the first linear portion 111 and the sensor S intersect and a second intersection X2 (see FIG. 8) that is a position where the second linear portion 112 and the sensor S intersect.

As a fifth step, the printing apparatus 1 is capable of executing steps S190 to S210. In steps S190 to S210, the printing apparatus 1 calculates, based on the first intersection X1 and the second intersection X2 detected in step S160, the conveyance error E that has occurred in the conveyance of the medium P in step S130 and corrects the conveyance amount of the medium P by the rollers 6.

As explained above, the printing apparatus 1 in the present embodiment includes the sensor S capable of moving in the width direction W orthogonal to the conveyance direction T and detecting the detection pattern ID formed by discharging ink onto the medium P, detects the detection pattern ID to calculate the conveyance error E generated before and after conveying the medium P by the predetermined amount, and corrects the conveyance amount of the medium P by the rollers 6. As explained above, since the printing apparatus 1 is configured to detect the detection pattern ID using the small sensor S capable of moving in the width direction W orthogonal to the conveyance direction T and calculate the conveyance error E, it is possible to reduce a risk of causing an increase in a driving load, an increase in apparatus cost, and the like. It is possible to print the detection pattern ID and automatically correct, with the sensor S, the conveyance error E that occurs in the conveyance of the medium P. It is possible to reduce a risk of requiring time and effort for detection and correction of the conveyance error E.

Subsequently, a principle of being able to calculate the conveyance error E involved in the frame feeding by obtaining the distance B between the detection pattern ID of the rear end of the first pattern ID1 and the detection pattern ID of the front end of the second pattern ID2 is explained with reference to FIG. 8. Here, a first pattern ID1-1 represented by a solid line in FIG. 8 represents a case in which a conveyance amount involved in the frame feeding is appropriate. In this case, a distance B1 actually measured as the distance B between the detection pattern ID of the rear end of the first pattern ID1 and the detection pattern ID of the front end of the second pattern ID2 is equal to the distance C that is the reference distance corresponding to the theoretical value calculated from image data.

A first pattern ID1-2 in FIG. 8 represents a case in which the conveyance amount involved in the frame feeding is larger than an appropriate conveyance amount. When the conveyance amount involved in the frame feeding is larger than the appropriate conveyance amount, the first pattern ID1-2 represented by a broken line is arranged further on an advancing direction side (the right side in the figure) in the conveyance direction T compared with the second pattern ID2. Here, since the first linear portion 111 and the second linear portion 112 detected by the sensor S are tilted with respect to the conveyance direction T, a distance B2 actually measured as the distance B between the detection pattern ID of the rear end of the first pattern ID1 and the detection pattern ID of the front end of the second pattern ID2 is larger than the distance C that is the reference distance.

Here, when a tilt from the width direction W in an extending direction of the first linear portion 111 and the second linear portion 112 is represented as θ, a conveyance error E2 corresponding to the first pattern ID1-2 can be represented as (B2-C) tan θ using the distance B2 serving as the distance B in this case and the distance C that is the reference distance. For example, when the first linear portion 111 and the second linear portion 112 are tilted by 45° with respect to the width direction W, that is, when tan θ is 1, the conveyance error E2 can be calculated as B2−C.

On the other hand, a first pattern ID1-3 in FIG. 8 represents a case in which the conveyance amount involved in the frame feeding is smaller than the appropriate conveyance amount. When the conveyance amount involved in the frame feeding is smaller than the appropriate conveyance amount, the first pattern ID1-3 represented by an alternate long and short dash line is arranged on the opposite side (the left side in the figure) to the advancing direction in the conveyance direction T compared with the second pattern ID2. A distance B3 actually measured as the distance B between the detection pattern ID of the rear end of the first pattern ID1 and the detection pattern ID of the front end of the second pattern ID2 is smaller than the distance C that is the reference distance. When the tilt from the width direction W in the extending direction of the first linear portion 111 and the second linear portion 112 is represented as θ, a conveyance error E3 corresponding to the first pattern ID1-3 can be represented as (B3-C) tan θ using the distance B3 serving as the distance B in this case and the distance C that is the reference distance.

To explain the above from another viewpoint, in steps S190 to S210 serving as the fifth step, the printing apparatus 1 in the present embodiment calculates the conveyance error E as (B−C) tan θ, where B is the distance in the width direction W between the position of the first intersection X1 and the position of the second intersection X2, C is the reference distance that is the theoretical value in the width direction W between the first linear portion 111 and the second linear portion 112, and θ is an angle obtained by subtracting a tilt of the first linear portion 111 with respect to the conveyance direction T from 90 degrees. By calculating the conveyance error E as explained above, it is possible to accurately and easily calculate the conveyance error E. By calculating the conveyance error E as (B−C) tan θ, a conveyance amount (a frame feeding amount) after the correction is A−{(B−C) tan θ}.

Here, the printing apparatus 1 is configured such that the length of the detection region in the conveyance direction T of the sensor S of the printing apparatus 1 in the present embodiment is smaller than the length of the overlapping portion of the first linear portion 111 located at the first ideal position and the second linear portion 112 when viewed in the width direction W in the conveyance direction T. Since the printing apparatus 1 in the present embodiment is configured as explained above, a large sensor such as a line scanner does not have to be used and a sensor can be particularly reduced in size. Therefore, the printing apparatus 1 in the present embodiment can particularly effectively suppress an increase in the driving load, an increase in the apparatus cost, and the like.

The printing apparatus 1 of the present embodiment can use various media P. The storage unit 7b provided in the control unit 7 stores types of the media P selectable as the medium P and the conveyance errors E corresponding to the respective types of the medium P in association with each other. Here, when starting printing, when the conveyance error E corresponding to a type of the medium P to be used is not stored in the storage unit 7b, the control unit 7 is configured to be capable of carrying out the first step to the fifth step, that is, step S110 to step S210 and calculating the conveyance error E corresponding to the type of the medium P to be used. That is, if data in which the type of the medium P and the conveyance error E corresponding the type are associated with each other is stored in the storage unit 7b, the printing apparatus 1 in the present embodiment can omit steps S110 to S190 and calculate the conveyance error E based on the data. Since the printing apparatus 1 in the present embodiment is configured as explained above, it is possible to simplify a correction process for the conveyance error E, for example, when the medium P used previously is used again.

Further, in the printing apparatus 1 of the present embodiment, when data in which the type of the medium P and the conveyance error E corresponding the type are associated with each other is not stored in the storage unit 7b, for example, when a new medium P is used, after calculating the conveyance error E corresponding to the type of the medium P to be used, the control unit 7 can cause the storage unit 7b to store the type of the medium P to be used and the calculated conveyance error E in association with each other. Since the printing apparatus 1 of the present embodiment is configured as explained above, it is possible to increase types of the medium P that can simplify the correction process for the conveyance error E.

On the other hand, in the printing apparatus 1 in the present embodiment, the control unit 7 can also carry out the first step to the fifth step, that is, steps S110 to S210 every time a print job is executed and calculate the conveyance error E. When a use environment of the printing apparatus 1 is different, a degree of swelling and shrinkage of the medium P sometimes also changes. However, since the printing apparatus 1 in the present embodiment is configured as explained above, the conveyance error E can be accurately corrected without being affected by the use environment of the printing apparatus 1 or the like because the conveyance error E is corrected every time a print job is executed.

In step S120 corresponding to the first step, as illustrated in FIG. 5, the printing apparatus 1 in the present embodiment can form the first pattern ID1 on the medium P by printing, on the medium P, image data obtained by combining image data of the image I to be printed in a print job and image data of the first pattern ID1. Similarly, in step S140 corresponding to the third step, the printing apparatus 1 in the present embodiment can form the second pattern ID2 on the medium P by printing, on the medium P, image data obtained by combining the image data of the image I to be printed in the print job and image data of the second pattern ID2. Since the printing apparatus 1 in the present embodiment is configured as explained above, it is possible to correct the conveyance error E taking into account a degree of swelling and shrinkage of the medium P due to an adhesion amount of ink involved in printing of an image in a print job. In the combination of the image data of the image I and the image data of the first pattern ID1 and the combination of the image data of the image I and the image data of the second pattern ID2, the image data may be combined after deleting the image data of the image I located around the first pattern ID1 and the second pattern ID2. As explained above, it is possible to avoid a risk of detection accuracy of the pattern ID being deteriorated by the image data of the image I.

The printing apparatus 1 in the present embodiment is also configured to be capable of forming the first pattern ID1 and the second pattern ID2 other than the first pattern ID1 formed by only the first linear portion 111 and the second pattern ID2 formed by only the second linear portion 112 illustrated in FIGS. 7 and 8 and the like. To explain from another viewpoint, the printing apparatus 1 in the present embodiment can correct the conveyance amount more accurately by changing the first pattern ID1 and the second pattern ID2 and detecting the first pattern ID1 and the second pattern ID2 twice with the sensor S.

Like the printing apparatus 1 in the present embodiment, in a configuration including the setting unit 2 in which the roll-shaped medium P is set and the winding unit 5 that winds the medium P conveyed from the setting unit 2 in a roll shape, the medium P is sometimes skew-conveyed. In the printing apparatus 1 in the present embodiment as well, there is a risk of the medium P being skew-conveyed on the platen 4. There is a risk of the medium P being skew-conveyed because ease of skew-conveying changes depending on, for example, the width of the medium P to be used or tension applied to the medium P in the conveyance direction T becomes non-uniform. When the medium P is skew-conveyed, it is generally difficult to accurately correct a conveyance amount.

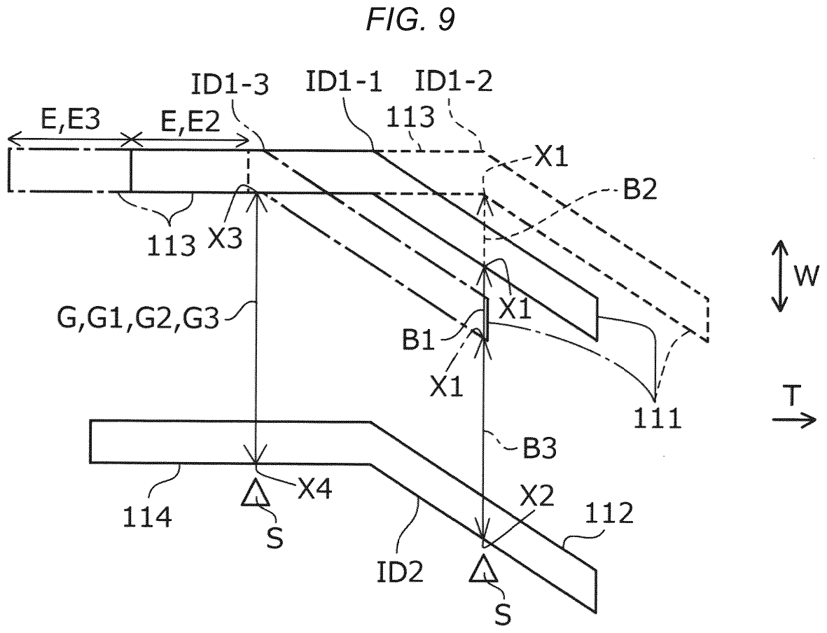

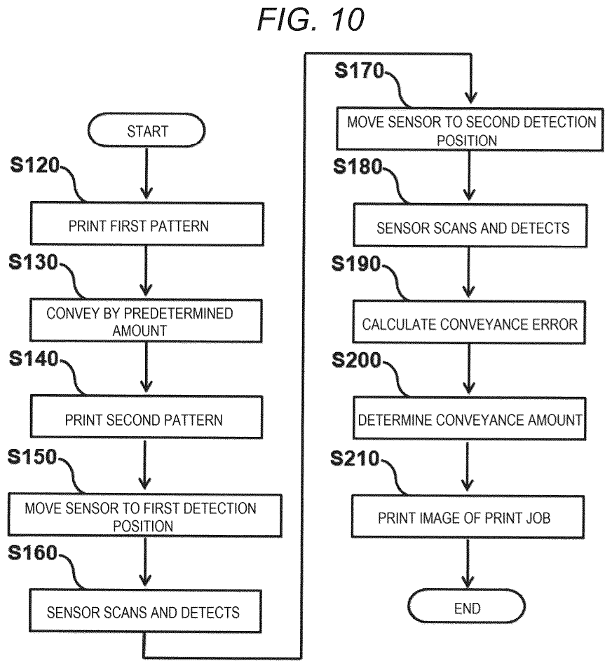

However, the printing apparatus 1 of the present embodiment can accurately correct a conveyance amount even when the medium P is skew-conveyed. As a method for the correction, the first pattern ID1 and the second pattern ID2 are formed into shapes illustrated in FIG. 9. Hereinafter, a printing method for accurately correcting a conveyance amount by printing the first pattern ID1 and the second pattern ID2 having the shapes illustrated in FIG. 9 is explained with reference to a flowchart of FIG. 10 while referring to FIG. 9. Here, FIG. 9 is a diagram corresponding to FIG. 8 and FIG. 10 is a diagram corresponding to FIG. 7. In the flowchart of FIG. 10, explanation concerning the same steps as the steps of the flowchart of FIG. 7 is simplified and omitted.

In the printing method represented by the flowchart of FIG. 10, step S110 of the flowchart of FIG. 7 is omitted. The printing method starts from the same step as step S120 of the flowchart of FIG. 7. However, a shape of the first pattern ID1 printed here is the shape of the first pattern ID1 illustrated in FIG. 9. Specifically, the first pattern ID1 has a third linear portion 113 extending parallel to the conveyance direction T in addition to the first linear portion 111.

In the printing method represented by the flowchart of FIG. 10, after the end of step S120, the medium is conveyed by the predetermined amount in step S130 and step S140 is executed. A shape of the second pattern ID2 printed in step S140 of the flowchart of FIG. 10 is the shape of the second pattern ID2 illustrated in FIG. 9. Specifically, the second pattern ID2 has a fourth linear portion 114 extending parallel to the conveyance direction T in addition to the second linear portion 112.

Subsequent steps S150 and S160 are the same as the steps in the flowchart of FIG. 7. That is, the distance B between the first linear portion 111 and the second linear portion 112 in the width direction W is measured. As in the case of the flowchart of FIG. 7, when a conveyance amount involved in the frame feeding is too large, as represented by the distance B2, the distance B is longer compared with the distance B1 in the case in which the conveyance amount is proper and, when the conveyance amount involved in the frame feeding is too small, as represented by the distance B3, the distance B is shorter than the distance B1 in the case in which the conveyance amount is proper.

In the printing method represented by the flowchart of FIG. 10, after the end of step S160, in step S170, the control unit 7 controls the driving of the driving unit 31 to move the position in the conveyance direction T of the sensor S of the carriage 8 to a position of the third linear portion 113 of the first pattern ID1 and a position of the fourth linear portion 114 of the second pattern ID2 illustrated in FIG. 9. Thereafter, in step S180, the sensor S is scanned in the width direction W to detect the third linear portion 113 of the first pattern ID1 and the fourth linear portion 114 of the second pattern ID2.

In step S190 after step S180, the control unit 7 obtains the distance B between the first linear portion 111 of the actually printed first pattern ID1 and the second linear portion 112 of the actually printed second pattern ID2 from detection results by the sensor S in step S160 and step S180 and obtains a distance G between the third linear portion 113 of the actually printed first pattern ID1 and the fourth linear portion 114 of the actually printed second pattern ID2, and calculates the conveyance error E from the distance B and the distance G. Here, the distance G is a constant value both when the conveyance amount is proper as represented by a distance G1 and when the conveyance amount is not proper as represented by a distance G2 and a distance G3. The distance G1 corresponds to the first pattern ID1-1, the distance G2 corresponds to the first pattern ID1-2, and the distance G3 corresponds to the first pattern ID1-3. However, when there is skew conveyance, the distance G varies depending on a degree of skew. Thus, in step S190, the degree of skew is calculated from the distance G and then the conveyance error E is calculated from the distance B. Then, as in the flowchart of FIG. 7, steps S200 and S210 are executed and the printing method represented by the flowchart of FIG. 10 ends.

Specifically, as represented by FIG. 9, in step S140 corresponding to the third step, the fourth linear portion 114 is formed at a position where at least a part of the fourth linear portion 114 overlaps the third linear portion 113 located at the first ideal position (corresponding to the first pattern ID1-1) when viewed in the width direction W and there is a gap (corresponding to the distance G1) between the third linear portion 113 located at the first ideal position and the fourth linear portion 114 in the width direction W. Then, in step S170 and step S180 between the third step (step S140) and the fifth step (step S190), the control unit 7 of the printing apparatus 1 in the present embodiment carries out a sixth step of, while moving the sensor S to traverse an overlapping portion where the third linear portion 113 located at the first ideal position and the fourth linear portion 114 when viewed in the width direction W, detecting a third intersection X3 that is a position where the third linear portion 113 and the sensor S intersect and a fourth intersection X4 that is a position where the fourth linear portion 114 and the sensor S intersect. Further, in the fifth step (step S190), the distance G in the width direction W between the third intersection X3 and the fourth intersection X4 is used instead of the distance C that is the reference distance calculated in step S110. By correcting the conveyance amount of the medium P as explained above, it is possible to accurately correct the conveyance amount of the medium P based on the actual measurement value even when, for example, skew conveyance or the like occurs.

The present disclosure is not limited to the embodiment explained above and can be implemented in various configurations without departing from the gist of the present disclosure. For example, technical features in the embodiment corresponding to technical features in the aspects described in the summary of the disclosure can be substituted and combined as appropriate in order to solve a part or all of the problems explained above or in order to achieve a part or all of the effects explained above. The technical features can be deleted as appropriate unless described in the present specification as essential technical features.

What is claimed is:

1. A printing apparatus comprising:
a conveyance unit configured to convey a medium in a conveyance direction;
a printing unit configured to discharge liquid onto the medium conveyed by the conveyance unit;
a sensor capable of moving in a width direction orthogonal to the conveyance direction and detecting a detection pattern formed by discharging the liquid onto the medium; and
a control unit,
the control unit carrying out:
a first step of controlling the printing unit to form, on the medium, a first pattern having a first linear portion that is one linear portion constituting the detection pattern and intersecting both of the conveyance direction and the width direction;
a second step of controlling the conveyance unit to convey the medium by a predetermined amount after the first pattern is formed;
a third step of controlling the printing unit to, when a position where the first linear portion is located when the medium is conveyed by the predetermined amount without causing a conveyance error in the second step is defined as a first ideal position, after the medium is conveyed by the predetermined amount, form, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction;
a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and
a fifth step of calculating the conveyance error of the medium in the second step based on the first intersection and the second intersection detected in the fourth step and correcting a conveyance amount of the medium by the conveyance unit.

2. The printing apparatus according to claim 1, wherein, in the fifth step, the conveyance error is calculated as (B-C) tan θ, where a distance in the width direction between a position of the first intersection and a position of the second intersection is B, a reference distance, which is a theoretical value in the width direction between the first linear portion and the second linear portion is C, and an angle obtained by subtracting a tilt of the first linear portion with respect to the conveyance direction from 90 degrees is θ.

3. The printing apparatus according to claim 2, wherein
the first pattern has a third linear portion that is one linear portion parallel to the conveyance direction,
the second pattern has a fourth linear portion that is one linear portion parallel to the conveyance direction,
in the third step, the fourth linear portion is formed at a position where at least a part of the fourth linear portion overlaps the third linear portion located at the first ideal position when viewed in the width direction and where there is a gap between the third linear portion located at the first ideal position and the fourth linear portion in the width direction, and
the control unit carries out, between the third step and the fifth step, a sixth step of, while moving the sensor to traverse, in the width direction, an overlapping portion where the third linear portion located at the first ideal position and the fourth linear portion when viewed in the width direction overlap, detecting a third intersection that is a position where the third linear portion and the sensor intersect and a fourth intersection that is a position where the fourth linear portion and the sensor intersect, and
in the fifth step, a distance in the width direction between the third intersection and the fourth intersection is used instead of the reference distance.

4. The printing apparatus according to claim 1, wherein a length of a detection region in the conveyance direction of the sensor is shorter than a length of the overlapping portion in the conveyance direction.

5. The printing apparatus according to claim 1, further comprising a storage unit configured to store types of media selectable as the medium and the conveyance errors corresponding to the respective types of the media in association with each other, wherein
when the conveyance error corresponding to a type of the medium to be used is not stored in the storage unit when starting printing, the control unit carries out the first step to the fifth step and calculates the conveyance error corresponding to the type of the medium to be used.

6. The printing apparatus according to claim 5, wherein, after calculating the conveyance error corresponding to the type of the medium to be used, the control unit causes the storage unit to store the type of the medium to be used and the calculated conveyance error in association with each other.

7. The printing apparatus according to claim 1, wherein the control unit carries out the first step to the fifth step every time a print job is executed and calculates the conveyance error.

8. The printing apparatus according to claim 1, wherein, in the first step, the control unit forms the first pattern on the medium by printing, on the medium, image data obtained by combining image data to be printed in a print job and image data of the first pattern and, in the third step, forms the second pattern on the medium by printing, on the medium, image data obtained by combining the image data to be printed in the print job and image data of the second pattern.

9. A printing method for a printing apparatus including:
a conveyance unit configured to convey a medium in a conveyance direction;
a printing unit configured to discharge liquid onto the medium conveyed by the conveyance unit; and
a sensor capable of moving in a width direction orthogonal to the conveyance direction and detecting a detection pattern formed by discharging the liquid onto the medium,
the printing method carrying out:
a first step of forming, by the printing unit, on the medium, a first pattern having a first linear portion that is one linear portion constituting the detection pattern and intersecting both of the conveyance direction and the width direction;
a second step of conveying the medium by a predetermined amount by the conveyance unit after the first pattern is formed;
a third step of, when a position where the first linear portion is located when the medium is conveyed by the predetermined amount without causing a conveyance error in the second step is defined as a first ideal position, after the medium is conveyed by the predetermined amount, forming, by the printing unit, on the medium, a second pattern having the second linear portion that is one linear portion constituting the detection pattern and parallel to the first linear portion at a position where at least a part of the second linear portion overlaps the first linear portion located at the first ideal position when viewed in the width direction and where there is a gap between the first linear portion located at the first ideal position and the second linear portion in the width direction;
a fourth step of, while moving the sensor to traverse, in the width direction, an overlapping portion where the first linear portion located at the first ideal position and the second linear portion when viewed in the width direction overlap, detecting a first intersection that is a position where the first linear portion and the sensor intersect and a second intersection that is a position where the second linear portion and the sensor intersect; and
a fifth step of calculating the conveyance error of the medium in the second step based on the first intersection and the second intersection detected in the fourth step and correcting a conveyance amount of the medium by the conveyance unit.
